(19) United States
(12) Patent Application Publication
(10) Pub. No.: US 2006/0108705 A1
(43) Pub. Date: May 25, 2006

(54) METHOD FOR INJECTION MOLDING COMPONENT FITTINGS ON EXTRUDATES

(76) Inventor: William W. ROWLEY, Chagrin Falls, OH (US)

Correspondence Address: BUCKINGHAM, DOOLITTLE & BURROUGHS, LLP, 50 S. MAIN STREET, AKRON, OH, 44308, US

(21) Appl. No.: 10/904,694

(22) Filed: Nov. 23, 2004

(51) Int. Cl. B29C 45/14; B29C 47/00

(52) U.S. Cl. 264/150; 264/254; 29/527.1; 29/527.3

(57) ABSTRACT

The invention relates generally to push-to-connect fitting with greater cross-section dimensional control made by injection overmolding the male and female fittings onto a length of an extruded tube.

### TECHNICAL FIELD

The invention relates generally to the art of injection molding variously configured ends onto lengths of extruded plastic, more particularly, the invention relates to the post-extrusion processing of extruded profiles, such processing involving injection overmolding of fittings with tight dimensional control.

### BACKGROUND OF THE INVENTION

The joining of fitting ends onto lengths of extruded tubing has typically been effected by various ways. The most common typically involves insertion of a fitting end followed by crimping that end using a metallic band. Alternatively the fitting is affixed by the application of sonic welding, spin welding or solvent welding. The application of each of these processing techniques creates unique issues with either reproducibility typically leading to higher reject rates than commercially acceptable or entails a large component of manual labor. Additionally, it must be recognized that extrusion, the process by which much plastic tubing is made, is inherently imprecise from a tolerance perspective, particularly at the higher rates at which the extrusion lines are often run. In light of the fact that this tubing is subsequently used in an application which demands tight dimensional tolerances, inherent conflicts are inevitable.

Plastics extrusion processing is defined as converting plastic powder or granules into a continuous uniform melt and forcing this melt through a die which yields a desired shape. This melted material must then be cooled back to its solid state as it is held in the desired shape, so an end product can be realized.

Single screw extruders are the most common in use today. Extruder diameters range from ½″ to 12″ in a barrel inner diameter. The hopper of an extruder accepts granules or powder which pass through a vertical opening in the feed section where they are introduced to a rotating screw with spiral flights. The material is conveyed along the screw and heated inside the barrel, with the goal being to reach the die system in a totally melt phase at an acceptable and homogeneous temperature, and being pumped at a consistent output rate.

The barrel is heated and cooled by heater/cooler jackets surrounding its outer wall to aid in the melting of the material on the screw. Heater/coolers are electrically heated through heating elements cast into aluminum, with either cooling tubes also cast into the aluminum or deep fins cast on the outer surfaces of the heaters/coolers to allow air cooling of the barrel via blowers. Temperature of the various barrel zones are set according to the material, screw design, and processing goals. These barrel zone temperature settings vary widely, depending on the material used or the product being made while the control of the temperature at the deep barrel thermocouple position for a given situation is typically maintained within a close tolerance range to minimize variations of material exiting the die system. The screw is the heart of the extrusion process and designs for which have varied with time as understanding of the melting process of the plastic material moving along the screw has increased. Since some materials tend to trap air as they start to melt, or contain moisture or volatiles, that will create porosity in the final product, a vent is typically positioned at a point in the barrel to remove the porosity by allowing the escape of gases.

The melt must be shaped and cooled by product sizing and cooling equipment to its solid phase while forming a product that falls within given size tolerances. The dies to create the end products from a melt are varied depending on the shapes involved. Pipe and tubing are cooled through simple, open water troughs, or pulled through vacuum sizing tanks, where the melt is held in a sizing sleeve of a short time in a water filled vacuum chamber. Custom profiles come in various shapes and are commonly made of materials that have high melt viscosity, so they are easy to hold shape while they cool. These products can be cooled by forced air, water troughs, or water spray methods. The methods of getting the many shapes include various sizing fixtures to hold the extrudate as it is pulled through the system and cooled. The material can also be coextruded, i.e., made with more than one material. Coextrusion typically requires a dual-extrusion head and multiple extruders using a specialized die system to bring these layers together with a common sizing and shaping system. Rates of 100 feet per minute are routinely achieved.

To accurately maintain diameter and wall thickness of polymer tubes, a uniform flow rate of melt from the extruder must be guaranteed. All extruders, even those designed for producing extremely tight tolerances will exhibit some surging as a result of electrical drive control fluctuations, screw design, and the normal rheological variation in the polymer. Clearly, higher than commercially acceptable reject rates and waste levels will result if the process relies solely on extruder stability.

One heretofore little used methodology to compensate for the inherent variations in extrusion is the combination with injection overmolding. Injection molding of thermoplastics is a process by which plastic is melted and injected into a mold cavity void, defined in this instance as the void volume between the mold core body and the mold cavity. Once the melted plastic is in the mold, it cools to a shape that reflects the form of the cavity. The resulting part is a finished part needing no other work before assembly into or use as a finished part. The injection molding machine has two basic components: an injection unit to melt and transfer the plastic into the mold; and a clamp to hold the mold shut against injection pressures and for parts removal. The injection unit melts the plastic before it is injected into the mold, then injects the melt with controlled pressure and rate into the mold. After the injection cycle, the clamp gently opens the mold halves. As used in this application, injection overmolding builds on this technology, but additionally employs at least a partially inserted extrudate into the mold cavity, often in conjunction with an inserted mandrel.

Injection molding of thermoplastics is increasingly regarded as the preferred method for delivering high quality, value added commercial parts. This process allows for high volume production of complex tightly toleranced three-dimensional parts.

To date, there has been no technology described which combines the features of extrusion molding and injection overmolding to produce a push-to-connect fitting which is quick and inexpensive to manufacture yet is produced to tight dimensional tolerances.

### SUMMARY OF THE INVENTION

In accordance with this invention, there is disclosed a product made by a sequence of processing steps in which a push-to-connect fitting is manufactured to tight tolerances.

It is an object of this invention to illustrate a process which employs extrusion processing to produce large numbers of extrudates cut to a defined length for further processing by injection overmolding at each end (although the process could be limited to just one end in an alternative embodiment) to produce a fitting with minimal dimensional variations.

It is a further object of this invention to illustrate a process by which a push-to-connect fitting is manufactured in which injection overmolding of fittings onto an extrudate (with tight dimensional control and bond formation) is used to overcome the inherent dimensional variations produced by extrusion, thereby producing a more robust and repeatable part when compared to traditional insert crimping, spin welding, solvent welding or sonic welding.

It is another object of this invention to illustrate a process by which a fitting end is affixed to an extrudate in which injection overmolding produces a material-to-material bond thereby removing any potential leak-paths and a more robust method of fitting attachment.

It is yet another object of this invention to illustrate a process by which a fitting end is affixed to an extrudate in which a material-to-material bond is formed over a relatively long distance (e.g., ½ inch) thereby eliminating any leak path even with gaseous fumes. Traditional crimp fitting tend to have micro leaks.

These and other objects of the present invention will become more readily apparent from a reading of the following detailed description taken in conjunction with the accompanying drawings wherein like reference numerals indicate similar parts, and with further reference to the appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is an elevational view of a female quick connect fitting;

FIG. 2 is a cross-sectional view of FIG. 1 taken along line 2-2;

FIG. 3 is a cross-sectional view of an injection molded male push-to-connect fitting;

FIG. 4 is a side elevational view shown in cross-section for both the injection molded male and female quick connect fittings, the male fitting having a circumferential rib peripherally disposed thereupon; and

FIG. 5is a cross-sectional view of an injection molded male push-to-connect fitting involving a tie-layer adhesive.

### DETAILED DESCRIPTION OF THE INVENTION

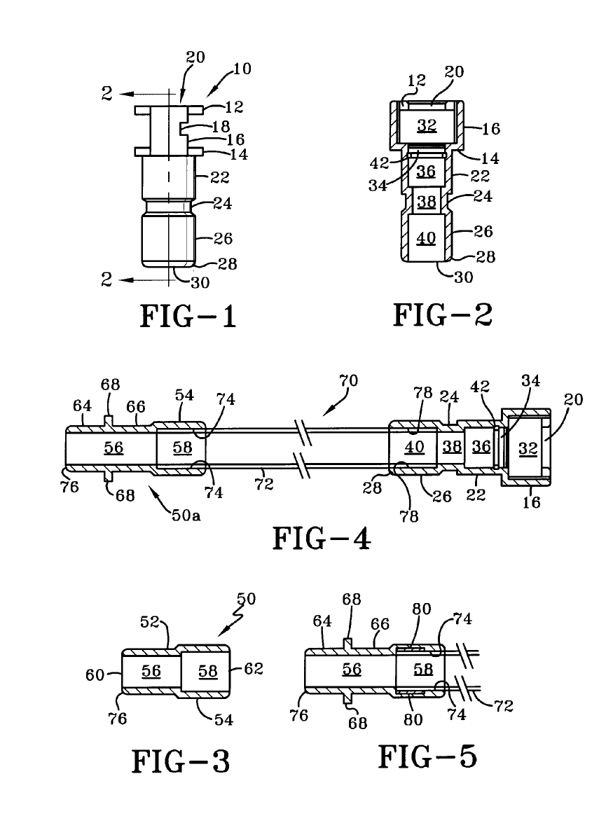

Referring now to the drawings wherein the showings are for purposes of illustrating the preferred embodiment of the invention only and not for purposes of limiting the same, the figures show male and female quick connect fittings in conjunction with their use as injection overmolded parts and fittings onto extruded lengths of tubing. FIGS. 1-2 illustrate the female fitting 10 while FIGS. 3-4 illustrate two embodiments of the male fitting 50, 50awith FIG. 3 illustrating but one example of a total connector system 70 employing both male and female fitting ends.

One of the most critical functions of push-to-connect fittings is the ability of the male and female end of the fitting to engage one another in a leak-proof manner. Present technology uses an extruded tube coupled to a flexible O-ring to effect this connection. The problem with this arrangement is that extrusion tolerances are higher than are acceptable for use when leak-proof engagement is required. Depending on extrusion speeds, standard extrusion dimensional tolerances can range from 1% to 6%. This is generally not precise enough to insure leak-proof engagement even with the inclusion of a flexible and compressible O-ring. By contrast, injection molding dimensional tolerances can range from 0.5% and lower. Additionally, injection overmolding permits complete control over all aspects of the geometry of the overmolded section of the fitting, thereby easily creating male fitting ends which are rounded without the need for a secondary end tip rounding operation required when only extruded parts are used. Male tip rounding is critical with push-to-connect fittings in that O-ring nicks are avoided, each nick representing a potential leak pathway. Therefore, the degree of dimensional reproducibility as well as geometry control is inherently greater with injection molding. This invention capitalizes on the speed capabilities and low cost of extrusion processing for the tubular part of the invention, and capitalizes on the finer dimensional tolerances and geometry control of injection overmolding for the push-to-connect fittings.

FIG. 1 illustrates one embodiment of a female push-to-connect end 10. This end has a generally circular top opening 20 defined by generally circular top rim 12 and bottom rim 14 in conjunction with vertically extending, mirror-image partial side walls 16, the combination thereof defining generally open axial bore entry cavity 32. Each of side walls 16 defines a partially circular segment having laterally opposed openings into which is inserted a resilient U-shaped snap-on retainer (not shown) for secure engagement about a peripheral circumferential surface an inserted male fitting. In vertical fluid engagement with entry cavity 32 is generally circular sealing cavity 36 defined by vertical walls 22. At a upper region 34 within said walls is positioned flexibly resilient rubber O-ring 42 which effects sealing engagement with an axially penetrating male fitting. Adjacent sealing cavity 36 and in fluid communication therewith, is interior cavity 38 defined by vertically-extending peripheral walls 24. At an opposed end of the female fitting is tube receiving cavity 40 having an opening 30 and vertically extending walls 26, said walls being optionally beveled 28 at an open end.

As better illustrated in FIG. 3, male tip 50 includes a tube receiving bore 58 defined by walls 58, open at one end 62 and an opposed tip insertion cavity 56 defined by walls 52 beveled 76 at open insertion end 60 thereof in axial fluid communication with said opposed tube receiving bore. In an optional configuration illustrated in FIG. 4, male tip 50a will have longer tube insertion walls 64, 66 and a circumferentially extending peripheral raised ring 68 for abutting contact with bottom rim 14 in use. Rim 68 is retained within entry cavity 32 by secure engagement of resilient U-shaped snap-on retainer preventing axial movement of the male insertion tip when the retainer is engaged about the interior insertion wall 66 the tip.

Where the invention departs from the teaching of the Prior Art is in the method used to prepare the assembled connector as illustrated in FIG. 4. As illustrated, male insertion tip 50a is affixed to extruded tube 72 by injection overmolding. In a preferred embodiment of the invention, the composition of the overmolded polymer will be such that it will be capable of at least some melt fusion at contacting interfaces 74, 78 with the composition of the plastic conduit, thereby maximizing the leak-proof characteristics of the interface between the plastic conduit and overmolded plastic. In a more preferred embodiment, this interfacial bonding will extend along the entire length of the physical contacting surfaces of the polymeric extruded tube 72 and the circumferential contacting internal surfaces of either the tube receiving cavity 58 of the male fitting 50, 50a as well as along the entire length of the physical contacting surfaces of the polymeric extruded tube 72 and the circumferential contacting internal surfaces of the tube receiving cavity 40 of the female fitting 10. However, it is recognized that in some embodiments of this invention, the bonding need only occur along a portion of these regions.

There are several means by which this may be effected. One of the simplest procedures is to insure that at least a component of the plastic conduit and that of the overmolded polymer is the same. Alternatively, it would be possible to insure that at least a portion of the polymer composition of the plastic conduit and that of the overmolded polymer is sufficiently similar or compatible so as to permit the melt fusion or blending or alloying to occur at least in the interfacial region between the exterior of the plastic conduit and the interior region of the overmolded polymer. Another manner in which to state this would be to indicate that at least a portion of the polymer compositions of the plastic conduit and the overmolded polymer are miscible.

In yet another embodiment, composites of rubber/thermoplastic blends are useful in adhering to thermoplastic materials used in the plastic conduit. These blends are typically in the form of a thermoplastic matrix containing rubber nodules functionalized and vulcanized during the mixing with the thermoplastic. The composite article is then obtained by overmolding the vulcanized rubber/thermoplastic blend onto the thermoplastic conduit. In this manner, the cohesion at the interface between these two materials is generally higher than the tensile strength of each of the two materials. The quantity of vulcanizable elastomer may be from 20 to 90% by weight of the vulcanizable elastomer block copolymer combination. This block copolymer compromises a polyether or amorphous polyester block as the flexible elastomeric block of the thermoplastic elastomer while polyamide, polyester or polyurethane semicrystalline blocks for the rigid elastomeric block of the thermoplastic elastomer. In this approach, it is postulated, without being held to any one theory of operation or mechanism, that the leak-proof aspect of this linkage utilizes a phenomenon typically used in the formation of moisture-proof electrical connections, i.e., dynamic vulcanization shrink wrap. In this manner, the overmolded polymer is formed having internally latent stresses which upon the application of heat, permit the relaxation of the stresses with resulting contraction of various polymeric strands within the composition during cooling.

In one specific embodiment of this invention which meets the above criteria, the plastic conduit will be polypropylene and the overmolded polymer is SANTOPRENE® thermoplastic elastomer by Advanced Elastomer Systems having a Shore A durometer of approximately 73. In this matter, due to the fact that the SANTOPRENE® polymer is an ethylene-propylene copolymer, the melt fusion of at least a portion of the polypropylene conduit profile with at least the propylene portion of the SANTOPRENE® will be effected. While a specific Shore A durometer is provided, the invention is not limited to any such value, and in fact, the Shore A durometer will range from approximately 45 to 85, more preferably, from 55 to 65.

In the overmolding process a plastic is melted and injected into a mold cavity void, defined in this instance as the void volume between the mold core body and the mold cavity. Once the melted plastic is in the mold, it cools to a shape that reflects the form of the cavity and core. The resulting part is a finished part needing no other work before assembly into or use as a finished part. The injection molding machine has at least one and sometimes, two basic components: an injection unit to melt and transfer the plastic into the mold, and optionally, a clamp to hold the mold shut against injection pressures and for parts removal. The injection unit melts the plastic before it is injected into the mold, then injects the melt with controlled pressure and rate into the mold.

Important factors in the processing of plastic include temperature, consistency, color dispersion and density of the melt. Conductive heat supplied by barrel temperature and mechanical heat generated by screw rotation both contribute to the processing of good quality melt. Often, most of the energy available for melting the plastic is supplied by screw rotation. Mixing happens between screw flights and the screw rotates, smearing the melted surface from the plastic pellet. This mixing/shearing action is repeated as the material moves along the screw until the plastic is completely melted.

If the polymer is a thermoset, injection molding uses a screw or a plunger to feed the polymer through a heated barrel to decrease its viscosity, followed by injection into a heated mold. Once the material fills the mold, it is held under pressure while chemical crosslinking occurs to make the polymer hard. The cured part is then ejected from the mold while at the elevated temperature and cannot be reformed or remelted.

When thermoplastics are heated in an injection press, they soften and as pressure is applied, flow from the nozzle of the press into an injection mold. The mold has cavities that, when filled with the thermoplastic material, define the molded part. The material enters these cavities through passages cut into the mold, called runners. The mold also has passages in it to circulate a coolant, usually water, through strategic areas to chill the hot plastic. As it cools, the thermoplastic material hardens. When cooled enough, the mold opens and the part is removed.

While the precise composition of the plastic connector and overmolded polymer are not required to be of any specified polymer, in general, there are several guidelines which are applicable in the practice of this invention. It is of course, recognized that the precise operating conditions utilized in the overmolding process are well-known in the art and are specific to each injection molded polymer. It is well within the skill of the art to determine the applicable conditions which will result in the appropriate overmolded polymer and plastic conduit. Shorter cycle times will be achieved with higher mold temperatures and vice-versa. Similar considerations will be applicable dependent upon the thickness of the overmolded part. The degree of flexibility of the plastic conduit is not of particular relevant for this invention. The plastic conduit can be a thermoplastic or a thermoset The key is that the overmolded polymer must be capable of forming a leak-proof bond, either chemical or physical, with the plastic of the conduit.

In the practice of this invention, illustrative and non-limiting examples of the polymers which may be used in various combinations to form the plastic conduit as well as polymers which may be used in the overmolding process would include: polyacetals, typically highly crystalline linear thermoplastic polymers of oxymethylene units; poly(meth)acrylics, typically belonging to two families of esters, acrylates and methacrylates; polyarylether ketones containing ether and ketone groups combined with phenyl rings in different sequences and polyether ketones; polyacrylonitrile resins wherein the principal monomer is acrylonitrile; nylons or polyamides, including various types of nylon-6, nylon-6/6, nylon-6/9, nylon-6/10, nylon-6/12, nylon-11, nylon-12; polyamide-imides formed by the condensation of trimellitic anhydride and various aromatic diamines; polyacrylates of aromatic polyesters derived from aromatic dicarboxylic acids and diphenols; polybutene resins based on poly( 1 -butene); polycarbonates, typically based on bisphenol A reacted with carbonyl chloride; polyalkylene terephthalates typically formed in a transesterification reaction between a diol and dimethyl terephthalate; polyetherimides, based on repeating aromatic imide and ether units; polyethylene homopolymers and copolymers, including all molecular weight and density ranges and degrees of crosslinking; polypropylene homopolymers and copolymers; ethylene acid copolymers from the copolymerization of ethylene with acrylic or methacrylic acid or their corresponding acrylate resins; ethylene-vinyl acetate copolymers from the copolymerization of ethylene and vinyl acetate; ethylene-vinyl alcohol copolymers; polyimides derived from the aromatic diamines and aromatic dianhydrides; polyphenylene oxides including polystyrene miscible blends; polyphenylene sulfides; acrylonitrile butadiene styrene terpolymers; polystyrenes; styrene-acrylonitrile copolymers; styrene-butadiene copolymers thermoplastic block copolymers; styrene maleic anhydride copolymers; polyarylsulfones; polyethersulfones; polysulfones; thermoplastic elastomers covering a hardness range of from 30 Shore A to 75 Shore D, including styrenic block copolymers, polyolefin blends (TPOS), elastomeric alloys, thermoplastic polyurethanes (TPUS), thermoplastic copolyesters, and thermoplastic polyamides; polyvinyl chlorides and chlorinated polyvinyl chlorides; polyvinylidene chlorides; allyl thermosets of allyl esters based on monobasic and dibasic acids; bismaleimides based generally on the condensation reaction of a diamine with maleic anhydride; epoxy resins containing the epoxy or oxirane group, including those epoxy resins based on bisphenol A and epichlorohydrin as well as those based on the epoxidation of multifunctional structures derived from phenols and formaldehyde or aromatic amines and aminophenols; phenolic resins; unsaturated thermoset polyesters including those of the condensation product of an unsaturated dibasic acid (typically maleic anhydride) and a glycol, wherein the degree of unsaturation is varied by including a saturated dibasic acid; thermoset polyimides; polyurethanes containing a plurality of carbamate linkages; and urea and melamine formaldehyde resins (typically formed by the controlled reaction of formaldehyde with various compounds that contain the amino group).

The combination of the above polymers must satisfy at least two simultaneous conditions. First, the plastic conduit must not soften and begin melt flow to the point where it looses all structural integrity and second, the overmolded polymer must be capable of forming an essentially leak-proof interface with the plastic conduit, preferably through either a chemical and/or physical bond between the underlying plastic and the overmolded plastic. One of the keys is the recognition that the plastic conduit must be capable of maintaining structural integrity during the overmolding conditions during which the overmolded polymer is in melt flow. It is recognized however, that due to the presence of a metallic mandrel within the internal diameter of the plastic conduit, this concern is minimized. When using an internally-cooled mandrel, it is possible to heat the mold to a temperature than possible if the mandrel is not cooled.

While using polymer compositions which have differing softening points is one way to achieve the above objective, there are alternatives, one of which would include the use of two compositions which have the same softening point, but which are of different thickness. Through manipulation of the time, temperature and pressure conditions experienced during the molding operation, the plastic conduit would not experience melt flow, even though it had a similar softening point or range. It is also possible that through the incorporation of various additives in the polymeric compositions, e.g., glass fibers, heat stabilizers, anti-oxidants, plasticizers, etc., the softening temperatures of the polymers may be controlled.

In a preferred embodiment of the invention, the composition of the overmolded polymer will be such that it will be capable of at least some melt fusion with the composition of the plastic conduit, thereby maximizing the leak-proof characteristics of the interface between the plastic conduit and overmolded plastic. There are several means by which this may be effected. One of the simplest procedures is to insure that at least a component of the plastic conduit and that of the overmolded polymer is the same. Alternatively, it would be possible to insure that at least a portion of the polymer composition of the plastic conduit and that of the overmolded polymer is sufficiently similar or compatible so as to permit the melt fusion or blending or alloying to occur at least in the interfacial region between the exterior of the plastic conduit and the interior region of the overmolded polymer. Another manner in which to state this would be to indicate that at least a portion of the polymer compositions of the plastic conduit and the overmolded polymer are miscible.

In an alternate embodiment, it is recognized that when the injection overmolded polymer is capable of shrinkage upon cooling, and the end-use application involves only low pressure, a mechanical shrink-fit may be employed.

While in a most preferred embodiment, all overmolded fittings will form a material-to-material bond therebetween, in some applications, where an absolutely leak-proof conduit is not required, or for applications wherein leakage is not an issue, it is possible that only one of the overmolded fittings will have this type of bond. For extremely forgiving applications, it is possible that neither fitting will have this bond.

Specific exemplary non-limiting examples of combinations of extrudates and overmolded polymer compositions include the following:

| Extruded Profile | Overmold Composition |
|---|---|
| Flexible polyethylene | High density polyethylene |
| Polypropylene | Santoprene ® |
| Linear low density polyethylene | Polyethylene |
| Nylon 6,6 | Nylon 12 |
| Linear low density polyethylene | Glass or talc filled polyethylene |
| Rigid PVC | Flexible PVC |

While material interfacial bonds 74, 78 have been described so far in the application, in an alternative embodiment, which expands the scope of this invention, it is possible to include an adhesive tie layer 80 at the interfacial bond region illustrated in FIG. 5, whereby mechanical multilayer attachment is substituted for chemical attachment. Tie-layer resins are used to bond dissimilar resins in composite structures. Tie-layer resins are synthesized mainly by chemically modifying polyolefin resins through the addition of functionality, although corona treatment may also impart this functionality. Acid or anhydride molecules are added to polyolefins through grafting or direct synthesis of copolymers or terpolymers. Non-limiting examples of adhesive tie layers include random ethylene vinyl acetate copolymers obtained by high pressure radical polymerization, random ethylene acrylic ester—maleic anhydride terpolymers obtained by high pressure polymerization, random ethylene acrylic ester—glycidyl methacrylate terpolymers, ethylene—vinyl acetate—maleic anhydride terpolymers, as well as ethylene acid copolymer blends consisting essentially of a high acid, high melt index acid copolymer blended with an acid copolymer that has both a lower acid level and a lower melt index than the high acid copolymer as illustrated in U.S. Pat. No. 6,500,556, published Dec. 31, 2002. In a manner analogous to that descrbed previously, adhesive tie layer preferentially extends along an entire length of the physically contacting regions, although as illustrated in FIG. 5; it need only extend along a portion thereof.

This invention has been described in detail with reference to specific embodiments thereof, including the respective best modes for carrying out each embodiment. It shall be understood that these illustrations are by way of example and not by way of limitation.

What is claimed is:

1. A process for making a push-to-connect fitting comprising the steps of:
(a) selecting a length of an extruded polymeric tube having a pair of opposed ends;
(b) inserting at least a portion of said tube into a first heated mold having a cavity;
(c) injection overmolding a female fitting having a cavity disposed therein over a first end of said tube, at least a portion of an exterior surface of said first end and an interior surface of said overmolded female fitting forming an interfacial bond therebetween;
(d) inserting at least a portion of a second end of said tube into a second heated mold having a cavity; and
(e) injection overmolding a male fitting comprising a cylindrical body and a beveled tip over said second end of said tube, at least a portion of an exterior surface of said second end and an interior surface of said overmolded male fitting forming an interfacial bond therebetween.

2. The process of claim 1 wherein said interfacial bond is along an entire length of a contacting region between at least one of said overmolded fittings and said tube.

3. The process of claim 1 wherein said interfacial bond is a material-to-material bond formed by melt fusion between said exterior surface of said tube and an internal surface of at least one of said overmolded fittings.

4. The process of claim 1 wherein said interfacial bond is a material-to-material bond formed between said exterior surface of said tube and an internal surface of at least one of said overmolded fittings wherein at least a portion of a polymeric composition of said at least one fitting and said tube are miscible.

5. The process of claim 1 wherein said interfacial bond is formed between said exterior surface of said tube and an internal surface of at least one of said overmolded fittings by dynamic vulcanization.

6. The process of claim 1 wherein said interfacial bond is formed between said exterior surface of said tube and an internal surface of at least one of said overmolded fittings by physical shrinkage of said at least one overmolded fitting about said tube upon cooling of said fitting.

7. The process of claim 1 which further comprises the step of adding a tie layer between at least a portion of said exterior surface of said tube and an internal surface of at least one of said overmolded fittings.

8. The process of claim 7 wherein said tie layer is an adhesive which bonds with at least one of said overmolded fittings and said tube.

9. The process of claim 1 which further comprises the step of at least partially inserting a mandrel into said tube prior to either of said steps of injection overmolding.

10. The process of claim 9 which further comprises the step of inserting at least O-ring into said receiving cavity of said female fitting.

11. A process for making a push-to-connect fitting comprising the steps of:
(a) selecting a length of an extruded polymeric tube having a pair of opposed ends;
(b) inserting at least a portion of said tube into a heated mold having a cavity; and
(c) injection overmolding at least one fitting onto at least one end of said tube, at least a portion of an exterior surface of said one end and said overmolded fitting forming an interfacial bond therebetween.

12. The process of claim 11 wherein said fitting is selected from the group consisting of a male fitting and a female fitting, and wherein
(a) said female fitting has at least one receiving cavity disposed therein, and
(b) said male fitting comprises a cylindrical body having a beveled tip.

13. The process of claim 12 wherein said interfacial bond is along an entire length of a contacting region between said at least one overmolded fitting and said tube.

14. The process of claim 12 wherein said interfacial bond is a material-to-material bond formed by melt fusion between said exterior surface of said tube and an internal surface of said at least one overmolded fitting.

15. The process of claim 12 wherein said interfacial bond is a material-to-material bond formed between said exterior surface of said tube and an internal surface of said overmolded fitting wherein at least a portion of a polymeric composition of said at least one fitting and said tube are miscible.

16. The process of claim 12 wherein said interfacial bond is formed between said exterior surface of said tube and an internal surface of said at least one overmolded fitting by dynamic vulcanization.

17. The process of claim 12 wherein said interfacial bond is formed between said exterior surface of said tube and an internal surface of said at least one overmolded fitting by physical shrinkage of said at least one overmolded fitting about said tube upon cooling of said at least one fitting.

18. The process of claim 12 which further comprises the step of adding a tie layer between at least a portion of said exterior surface of said tube and an internal surface of said at least one overmolded fitting.

19. The process of claim 18 wherein said tie layer is an adhesive which bonds with both said at least one overmolded fitting and said tube.

20. The process of claim 12 which further comprises the step of at least partially inserting a mandrel into said tube prior to said step of injection overmolding.

21. The process of claim 20 which further comprises the step of inserting at least O-ring into said receiving cavity of said female fitting.

22. A process for making a push-to-connect fitting comprising the steps of:
(a) extruding a polymeric tube;
(b) cutting said tube to a predefined length;
(c) at least partially inserting one end of said tube into a first heated mold having a cavity designed for a female fitting;
(d) injection overmolding a female fitting over a first end of said tube, at least a portion of an exterior surface of said first end and an interior surface of said overmolded female fitting forming an interfacial bond therebetween;
(e) at least partially inserting a second opposed end of said tube into a second heated mold designed for a male fitting;
(f) injection overmolding a male fitting over said second end of said tube, at least a portion of an exterior surface of said opposed second end and an interior surface of said overmolded male fitting forming an interfacial bond therebetween; and
(g) inserting at least one O-ring into said at least one receiving cavity in said female fitting.

23. The process of claim 22 wherein said interfacial bond is along an entire length of a contacting region between at least one of said overmolded fittings and said tube.

24. The process of claim 22 wherein said interfacial bond is a material-to-material bond formed by melt fusion between said exterior surface of said tube and an internal surface of at least one of said overmolded fittings.

25. The process of claim 22 wherein said interfacial bond is a material-to-material bond formed between said exterior surface of said tube and an internal surface of said overmolded fittings wherein at least a portion of a polymeric composition of at least one of said fittings and said tube are miscible.

26. The process of claim 22 wherein said interfacial bond is formed between said exterior surface of said tube and an internal surface of at least one of said overmolded fittings by dynamic vulcanization.

27. The process of claim 22 wherein said interfacial bond is formed between said exterior surface of said tube and an internal surface of at least one of said overmolded fittings by physical shrinkage of said at least one overmolded fitting about said tube upon cooling of said fitting.

28. The process of claim 22 which further comprises the step of adding a tie layer between at least a portion of said exterior surface of said tube and an internal surface of at least one of said overmolded fittings.

29. The process of claim 28 wherein said tie layer is an adhesive which bonds with at least one of said overmolded fittings and said tube.

30. The process of claim 22 which further comprises the step of at least partially inserting a mandrel into said tube prior to either of said steps of injection overmolding.

31. A process for making a push-to-connect fitting comprising the steps of:
(a) extruding a polymeric tube;
(b) cutting said tube to a predefined length;
(c) inserting at least a portion of one end of said tube into a heated mold having a cavity; and
(d) injection overmolding at least one fitting onto at least one end of said tube, at least a portion of an exterior surface of said one end and an interior surface of said overmolded fitting forming an interfacial bond therebetween.

32. The process of claim 31 wherein said at least one fitting is selected from the group consisting of a male fitting and a female fitting, and wherein
(a) said female fitting has at least one receiving cavity disposed therein, and
(b) said male fitting comprises a cylindrical body having a beveled tip.

33. The process of claim 32 wherein said interfacial bond is along an entire length of a contacting region between said at least one overmolded fitting and said tube.

34. The process of claim 32 wherein said interfacial bond is a material-to-material bond formed by melt fusion between said exterior surface of said tube and an internal surface of said at least one overmolded fitting.

35. The process of claim 32 wherein said interfacial bond is a material-to-material bond formed between said exterior surface of said tube and an internal surface of said at least one overmolded fitting wherein at least a portion of a polymeric composition of said at least one fitting and said tube are miscible.

36. The process of claim 32 wherein said interfacial bond is formed between said exterior surface of said tube and an internal surface of said overmolded fitting by dynamic vulcanization.

37. The process of claim 32 wherein said interfacial bond is formed between said exterior surface of said tube and an internal surface of said at least one overmolded fitting by physical shrinkage of said at least one overmolded fitting about said tube upon cooling of said fitting.

38. The process of claim 32 which further comprises the step of adding a tie layer between at least a portion of said exterior surface of said tube and an internal surface of said at least one overmolded fitting.

39. The process of claim 38 wherein said tie layer is an adhesive which bonds with said at least one overmolded fitting and said tube.

40. The process of claim 32 which further comprises the step of at least partially inserting a mandrel into said tube prior to said step of injection overmolding.

41. The process of claim 40 which further comprises th step of inserting at least one O-ring into said receiving cavity of said female fitting.

42. A process for making a push-to-connect fitting comprising the steps of:
(a) selecting a length of an extruded polymeric tube having opposed ends and a cross-sectional dimensional variability of greater than 1%;
(b) inserting at least a portion of a first end of said tube into a first heated mold having a cavity;
(c) injection overmolding a female fitting over said first end of said tube, at least a portion of an exterior surface of said first end and an interior surface of said overmolded female fitting forming an interfacial bond therebetween;
(d) inserting at least a portion of a second end of said tube into a second heated mold having a cavity;
(e) injection overmolding a male fitting over said second end of said tube, at least a portion of an exterior surface of said second end and an interior surface of said overmolded male fitting forming an interfacial bond therebetween, said male fitting comprising a cylindrical body with a beveled tip, said cylindrical body having a cross-sectional dimensional variability of less than 1%; and
(f) inserting at least one O-ring into said receiving cavity of said female fitting.

43. The process of claim 42 wherein said interfacial bond is along an entire length of a contacting region between at least one of said overmolded fittings and said tube.

44. The process of claim 42 wherein said interfacial bond is a material-to-material bond formed by melt fusion between said exterior surface of said tube and an internal surface of at least one of said overmolded fittings.

45. The process of claim 42 wherein said interfacial bond is a material-to-material bond formed between said exterior surface of said tube and an internal surface of at least one of said overmolded fittings wherein at least a portion of a polymeric composition of at least one of said fittings and said tube are miscible.

46. The process of claim 42 wherein said interfacial bond is formed between said exterior surface of said tube and an internal surface of said overmolded fitting by dynamic vulcanization.

47. The process of claim 42 wherein said interfacial bond is formed between said exterior surface of said tube and an internal surface of at least one of said overmolded fittings by physical shrinkage of at least one of said overmolded fittings about said tube upon cooling of said fitting.

48. The process of claim 42 which further comprises the step of adding a tie layer between at least a portion of said exterior surface of said tube and an internal surface of at least one of said overmolded fittings.

49. The process of claim 48 wherein said tie layer is an adhesive which bonds with at least one of said overmolded fittings and said tube.

50. The process of claim 42 which further comprises the step of at least partially inserting a mandrel into said tube prior to either of said steps of injection overmolding.

51. A process for making a push-to-connect fitting comprising the steps of:
(a) selecting a length of an extruded polymeric tube having opposed ends and a cross-sectional dimensional variability of greater than 1%;
(b) inserting at least a portion of one end of said tube into a first heated mold having a cavity;
(c) injection overmolding a male fitting over at least one end of said tube, at least a portion of an exterior surface of said end and an interior surface of said overmolded male fitting forming an interfacial bond therebetween, at least a portion of said male fitting with beveled tip and cylindrical body dimensioned to matingly fit into said receiving cavity in a female fitting, said cylindrical body having a cross-sectional dimensional variability of less than 1%.

52. The process of claim 51 wherein said interfacial bond is along an entire length of a contacting region between said overmolded fitting and said tube.

53. The process of claim 51 wherein said interfacial bond is a material-to-material bond formed by melt fusion between said exterior surface of said tube and an internal surface of said overmolded fitting.

54. The process of claim 51 wherein said interfacial bond is a material-to-material bond formed between said exterior surface of said tube and an internal surface of said overmolded fitting wherein at least a portion of a polymeric composition of said fitting and said tube are miscible.

55. The process of claim 51 wherein said interfacial bond is formed between said exterior surface of said tube and an internal surface of said overmolded fitting by dynamic vulcanization.

56. The process of claim 51 wherein said interfacial bond is formed between said exterior surface of said tube and an internal surface of said overmolded fitting by physical shrinkage of said overmolded fitting about said tube upon cooling of said fitting.

57. The process of claim 51 which further comprises the step of adding a tie layer between at least a portion of said exterior surface of said tube and an internal surface of said overmolded fitting.

58. The process of claim 57 wherein said tie layer is an adhesive which bonds with both said overmolded fitting and said tube.

59. The process of claim 51 which further comprises the step of at least partially inserting a mandrel into said tube prior to either of said steps of injection overmolding.

60. A process for making a push-to-connect fitting comprising the steps of:
(a) selecting a length of an extruded polymeric tube having opposed ends;
(b) adding an adhesive tie layer to at least one end of said tube;
(c) inserting at least a portion of a first end of said tube into a first heated mold having a cavity;
(d) injection overmolding a female fitting over said first end of said tube, at least a portion of an exterior surface of said end and an exterior surface of said overmolded female fitting forming an interfacial bond therebetween;
(e) inserting at least a portion of a second end of said tube into a second heated mold having a cavity;
(f) injection overmolding said male fitting over an opposed second end of said tube, at least a portion of an exterior surface of said opposed second end and an exterior surface of said overmolded male fitting forming an interfacial bond therebetween.

61. The process of claim 60 wherein said interfacial bond is along an entire length of a contacting region between at least one of said overmolded fittings and said tube.

62. The process of claim 60 wherein said interfacial bond is a material-to-material bond formed by melt fusion between said exterior surface of said tube and an internal surface of at least one of said overmolded fittings.

63. The process of claim 60 wherein said interfacial bond is a material-to-material bond formed between said exterior surface of said tube and an internal surface of at least one of said overmolded fittings wherein at least a portion of a polymeric composition of at least one of said fittings and said tube are miscible.

64. The process of claim 60 wherein said interfacial bond is formed between said exterior surface of said tube and an internal surface of at least one of said overmolded fittings by dynamic vulcanization.

65. The process of claim 60 wherein said interfacial bond is formed between said exterior surface of said tube and an internal surface of at least one of said overmolded fittings by physical shrinkage of at least one of said overmolded fittings about said tube upon cooling of said fitting.

66. The process of claim 60 wherein said tie layer is an adhesive which bonds with at least one of said overmolded fittings and said tube.

67. The process of claim 60 which further comprises the step of at least partially inserting a mandrel into said tube prior to either of said steps of injection overmolding.

68. A process for making a push-to-connect fitting comprising the steps of:
(a) selecting a length of an extruded polymeric tube having opposed ends;
(b) adding an adhesive tie layer to at least one end of said tube;
(c) inserting at least a portion of said one end having said adhesive tie layer of said tube into a heated mold having a cavity;
(d) injection overmolding at least one fitting onto said one end having said adhesive tie layer, at least a portion of an exterior surface of said one end and an exterior surface of said at least one overmolded fitting forming an interfacial bond therebetween.

69. The process of claim 68 wherein said at least one fitting is selected from the group consisting of a male fitting and a female fitting, and wherein
(a) said female fitting has at least one receiving cavity disposed therein, and
(b) said male fitting comprises a cylindrical body having a beveled tip.

70. The process of claim 69 wherein said interfacial bond is along an entire length of a contacting region between said at least one overmolded fitting and said tube.

71. The process of claim 69 wherein said interfacial bond is a material-to-material bond formed by melt fusion between said exterior surface of said tube and an internal surface of said at least one overmolded fitting.

72. The process of claim 69 wherein said interfacial bond is a material-to-material bond formed between said exterior surface of said tube and an internal surface of said at least one overmolded fitting wherein at least a portion of a polymeric composition of said at least one fitting and said tube are miscible.

73. The process of claim 69 wherein said interfacial bond is formed between said exterior surface of said tube and an internal surface of said overmolded fitting by dynamic vulcanization.

74. The process of claim 69 wherein said interfacial bond is formed between said exterior surface of said tube and an internal surface of said at least one overmolded fitting by physical shrinkage of said at least one overmolded fitting about said tube upon cooling of said fitting.

75. The process of claim 69 wherein said tie layer is an adhesive which bonds with said at least one overmolded fitting and said tube.

76. The process of claim 75 which further comprises the step of at least partially inserting a mandrel into said tube prior to said step of injection overmolding.

77. The process of claim 76 which further comprises th step of inserting at least one O-ring into said receiving cavity of said female fitting.

78. A process for making a fitting comprising the steps of:
(a) selecting a length of an extruded polymeric profile having a pair of opposed ends;
(b) inserting at least a portion of said extruded profile into a first heated mold having a cavity;
(c) injection overmolding a first overmolded profile over a first end of said extruded profile, at least a portion of an exterior surface of said first end and an interior surface of said first overmolded profile forming an interfacial bond therebetween;
(d) inserting at least a portion of a second end of said extruded profile into a second heated mold having a cavity; and
(e) injection overmolding a second overmolded profile over said second end of said extruded profile, at least a portion of an exterior surface of said second end and an interior surface of said overmolded second overmolded profile forming an interfacial bond therebetween.

79. The process of claim 78 wherein said interfacial bond is along an entire length of a contacting region between at least one of said overmolded profiles and said extruded profile.

80. The process of claim 78 wherein said interfacial bond is a material-to-material bond formed by melt fusion between said exterior surface of said extruded profile and an internal surface of at least one of said overmolded profiles.

81. The process of claim 78 wherein said interfacial bond is a material-to-material bond formed between said exterior surface of said extruded profile and an internal surface of at least one of said overmolded profile wherein at least a portion of a polymeric composition of said at least one overmolded profile and said extruded profile are miscible.

82. The process of claim 78 which further comprises the step of adding a tie layer between at least a portion of said exterior surface of said extruded profile and an internal surface of at least one of said overmolded profiles.

83. The process of claim 82 wherein said tie layer is an adhesive which bonds with at least one of said overmolded profiles and said extruded profile.

84. The process of claim 78 which further comprises the step of at least partially inserting a mandrel into said extruded profile prior to either of said steps of injection overmolding.

85. A process for making a fitting comprising the steps of:
(a) selecting a length of an extruded polymeric profile having a pair of opposed ends;
(b) inserting at least a portion of said extruded profile into a heated mold having a cavity; and
(c) injection overmolding at least one overmolded profile onto at least one end of said extruded profile, at least a portion of an exterior surface of said one end and said overmolded profile forming an interfacial bond therebetween.

86. The process of claim 85 wherein said interfacial bond is along an entire length of a contacting region between said at least one overmolded profile and said extruded profile.

87. The process of claim 85 wherein said interfacial bond is a material-to-material bond formed by melt fusion between said exterior surface of said extruded profile and an internal surface of said at least one overmolded profile.

88. The process of claim 85 wherein said interfacial bond is a material-to-material bond formed between said exterior surface of said extruded profile and an internal surface of said overmolded extruded profile wherein at least a portion of a polymeric composition of said at least one overmolded profile and said extruded profile are miscible.

89. The process of claim 85 which further comprises the step of adding a tie layer between at least a portion of said exterior surface of said extruded profile and an internal surface of said at least one overmolded profile.

90. The process of claim 89 wherein said tie layer is an adhesive which bonds with both said at least one overmolded profile and said extruded profile.

91. A process for making a fitting comprising the steps of:
(a) selecting a length of an extruded polymeric profile having opposed ends and a cross-sectional dimensional variability of greater than 1%;
(b) inserting at least a portion of a first end of said extruded profile into a first heated mold having a cavity;
(c) injection overmolding a first overmolded profile over said first end of said extruded profile, at least a portion of an exterior surface of said first end and an interior surface of said first overmolded profile forming an interfacial bond therebetween;
(d) inserting at least a portion of a second end of said extruded profile into a second heated mold having a cavity;
(e) injection overmolding a second overmolded profile over said second end of said extruded profile, at least a portion of an exterior surface of said second end and an interior surface of said overmolded second profil forming an interfacial bond therebetween; and
(f) said first and second profiles having a cross-sectional dimensional variability of less than 1%.

92. The process of claim 91 wherein said interfacial bond is along an entire length of a contacting region between at least one of said overmolded profiles and said extruded profile.

93. The process of claim 91 wherein said interfacial bond is a material-to-material bond formed by melt fusion between said exterior surface of said extruded profile and an internal surface of at least one of said overmolded profiles.

94. The process of claim 91 wherein said interfacial bond is a material-to-material bond formed between said exterior surface of said extruded profile and an internal surface of at least one of said overmolded profiles wherein at least a portion of a polymeric composition of at least one of said overmolded profiles and said extruded profile are miscible.

95. The process of claim 91 which further comprises the step of adding a tie layer between at least a portion of said exterior surface of said extruded profile and an internal surface of at least one of said overmolded profiles.

96. The process of claim 95 wherein said tie layer is an adhesive which bonds with at least one of said overmolded profiles and said extruded profile.

97. A process for making a fitting comprising the steps of:
(a) selecting a length of an extruded polymeric profile having opposed ends and a cross-sectional dimensional variability of greater than 1%;
(b) inserting at least a portion of one end of said profile into a first heated mold having a cavity;
(c) injection overmolding a first overmolded profile over at least one end of said extruded profile, at least a portion of an exterior surface of said end and an interior surface of said overmolded profile forming an interfacial bond therebetween, said overmolded profile having a cross-sectional dimensional variability of less than 1%.

98. The process of claim 97 wherein said interfacial bond is along an entire length of a contacting region between said overmolded profile and said extruded profile.

99. The process of claim 97 wherein said interfacial bond is a material-to-material bond formed by melt fusion between said exterior surface of said extruded profile and an internal surface of said overmolded profile.

100. The process of claim 97 wherein said interfacial bond is a material-to-material bond formed between said exterior surface of said extruded profile and an internal surface of said overmolded profile wherein at least a portion of a polymeric composition of said overmolded profile and said extruded profile are miscible.

101. The process of claim 97 which further comprises the step of adding a tie layer between at least a portion of said exterior surface of said extruded profile and an internal surface of said overmolded profile.

102. The process of claim 101 wherein said tie layer is an adhesive which bonds with both said overmolded profile and said extruded profile.
